(19) United States
(12) Patent Application Publication
(10) Pub. No.: US 2015/0066513 A1
(43) Pub. Date: Mar. 5, 2015

(54) MECHANISM FOR PERFORMING SPEECH-BASED COMMANDS IN A SYSTEM FOR REMOTE CONTENT DELIVERY

(71) Applicant: CiiNOW, INC., Sunnyvale, CA (US)

(72) Inventor: Makarand DHARMAPURIKAR, Fremont, CA (US)

(73) Assignee: CIINOW, INC., Sunnyvale, CA (US)

(21) Appl. No.: 14/220,022

(22) Filed: Mar. 19, 2014

Related U.S. Application Data
(60) Provisional application No. 61/871,686, filed on Aug. 29, 2013.

(51) Int. Cl. H04N 21/422; G10L 25/48; G06F 17/28; G10L 15/30; H04N 21/478; G10L 21/0208; G10L 15/22

(52) U.S. Cl. CPC H04N 21/42206; G10L 21/0208; G10L 25/48; G10L 15/22; G10L 15/30; H04N 21/42203; H04N 21/4781; G06F 17/2881; G10L 2015/223
USPC 704/275

(57) ABSTRACT

A method for performing speech-based commands in a system for remote content delivery, includes receiving speech, recognizing the speech, transmitting the speech to a speech server, receiving a device-based signal corresponding to the speech from the speech server when the speech is a speech-based command, forwarding the device-based signal to a streaming server; and receiving content from the streaming server corresponding to the device-based signal.

### CROSS-REFERENCE TO RELATED APPLICATIONS

The present application claims the benefit of U.S. Provisional Patent Application No. 61/871,686, filed on Aug. 29, 2013, which is hereby incorporated by reference in its entirety.

### FIELD OF THE INVENTION

This invention relates to the field of remote content delivery, and in particular to a mechanism for performing speech-based commands in a system for remote content delivery.

### BACKGROUND

Remote content delivery is mechanism often used in the context of gaming to allow a user operating a client device to interact with content being generated remotely. For example, a user may be operating a client device that interacts with a game running on a remote server. User inputs may be transmitted from the client device to the remote server, where content in the form of game instructions or graphics may be generated for transmission back to the client device. Such remote interaction between users and games may occur during actual gameplay as well as during game menu interfacing.

Users typically provide input commands in the form of device-based signals to the client device using an input device, such as a game pad or remote control. The games running on the remote server are configured to interpret and respond to such device-based signals provided by the client device. While providing commands via an input device is the conventional approach for interacting with a game, it may be more natural for a user to provide certain commands to a game using speech. However, because games are generally configured to handle (e.g., interpret and respond to) device-based signals from input devices rather than speech-based commands, users are left with using input devices as their only means of providing commands for interactions with games.

### SUMMARY

Embodiments of the invention concern a mechanism for performing speech-based commands in a system for remote content delivery. According to some embodiments, speech based commands are provided by a client device to a speech server, which generates a device-based signal corresponding to the speech-based command. The device-based signal is then provided to a streaming server executing the game program and content is generated by the streaming server in response to the device-based signal. The content generated by the streaming server is then transmitted to the client device where it is processed and displayed. In this way, a user of a client device is allowed to interact with a game program configured to interpret and respond to device-based signals using speech-based commands without having to modify the game program.

Further details of aspects, objects and advantages of the invention are described below in the detailed description, drawings and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1 illustrates an example system for remote content delivery.

FIG. 2 illustrates a system for remote content delivery that utilizes device-based commands.

FIG. 3 illustrates a system for remote content delivery that utilizes speech-based commands according to some embodiments.

FIG. 4 is a flow diagram illustrating a method for processing speech-based commands in a system for remote content delivery according to some embodiments.

FIG. 5 is a flow diagram illustrating a method for providing speech-based commands in a system for remote content delivery according to some embodiments.

FIGS. 6A-E illustrate a method for providing and processing speech-based commands in a system for remote content delivery according to some embodiments.

FIG. 7 illustrates an alternative system for remote content delivery that utilizes speech-based commands according to some embodiments.

FIG. 8 is a flow diagram illustrating a method for processing speech-based commands in the system for remote content delivery of FIG. 7 according to some embodiments.

FIG. 9 is a flow diagram illustrating a method for providing speech-based commands in the system for remote content delivery of FIG. 7 according to some embodiments.

FIGS. 10A-F illustrate a method for providing and processing speech-based commands in a system for remote content delivery according to some embodiments.

FIG. 11 is a block diagram of an illustrative computing system suitable for implementing some embodiments of the present invention.

### DETAILED DESCRIPTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments”, in various places throughout this specification are not necessarily referring to the same embodiment or embodiments.

According to some embodiments, a system for remote content delivery is provided that utilizes speech-based commands according to some embodiments. Speech based commands are provided by a client device to a speech server, which generates a device-based signal corresponding to the speech-based command. The device-based signal is then provided to a streaming server executing the game program and content is generated by the streaming server in response to the device-based signal. The content generated by the streaming server is then transmitted to the client device where it is processed and displayed. In this way, a user of a client device is allowed to interact with a game program configured to interpret and respond to device-based signals using speech-based commands without having to modify the game program.

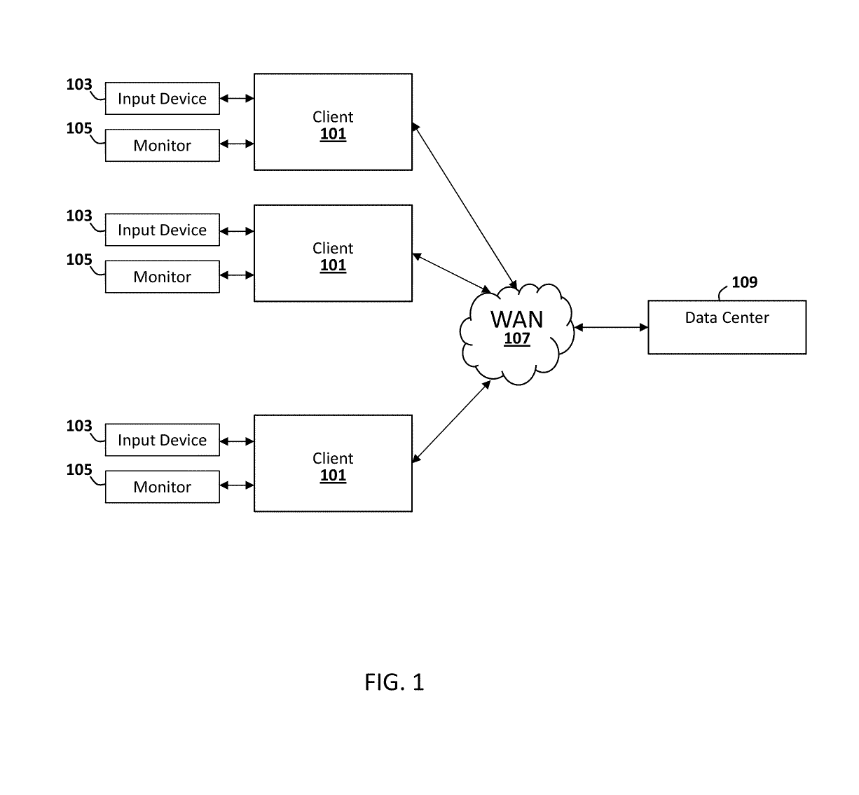

Remote content delivery is mechanism often used in the context of gaming to allow a user operating a client device to interact with content being generated remotely. FIG. 1 illustrates an example system 100 for remote content delivery. In the system 100 illustrated in FIG. 1, several client devices 101 interact with a remote server 109 over a network 107 (e.g., WAN). The remote server 109 and client devices 101 may all be located in different geographical locations, and each client device 101 may interact with a different game program running at the remote server 109.

The client devices 101 may be set-top boxes (STB), mobile phones, thin gaming consoles, or any other type of device capable of communicating with the remote server 109. Each client device 101 may be associated with an input device 103 and a monitor 105. Such input devices may include keyboards, joysticks, game controllers, motion sensors, touchpads, etc. A client device 101 interacts with a game program running at the remote server 109 by sending inputs in the form of device-based signals to the remote server 109 using its respective input device 103. Such interaction between users and games may occur during actual gameplay as well as during game menu interfacing.

Each game program is configured to interpret and respond to device-based signals. As used herein, the term device-based signal refers to an input signal generated by an input device that is natively understood by a game program. This is in contrast to speech-based commands that are not natively understood by a game program. User inputs in the form of device-based signals may be transmitted from the client device 101 to the remote server 109, where content is generated for transmission back to the client device 101. The remote server 109 interprets the device-based signals and generates content to be delivered to the client device 101 in accordance with device-based signals. Such content may take the form of game instructions for the client device 101 or rendered graphics for the client device 101. The generated content is then transmitted to client device 101 where it is processed for display on the monitor 105.

Various mechanisms for remote content generation and delivery are available. Some approaches for implementing remote content generation and delivery in conjunction with the present invention are described in co-pending U.S. Ser. No. 13/234,948; co-pending U.S. Ser. No. 13/329,422; co-pending U.S. Ser. No. 13/491,930; and co-pending U.S. Ser. No. 13/558,163, which are hereby incorporated by reference in their entirety.

By implementing remote content delivery, the workload of the client device 101 may be significantly reduced as a significant amount of the processing (e.g., CPU processing or GPU processing) may be performed at the remote server 109 rather than at the client device 101.

Users typically provide input commands in the form of device-based signals to the client device 101 using an input device 103, such as a game pad or remote control. Game programs running on the remote server 109 are configured to interpret and respond to such device-based signals provided by the input device 103. However, while providing commands in the form of device-based signals via an input device 103 is the conventional approach for interacting with a game program, it may be more natural for a user to provide certain input commands to a game using speech. However, because game programs are generally configured to handle device-based signals rather than speech-based commands, users are left with providing device-based signals using input devices as their only means of interacting with game programs.

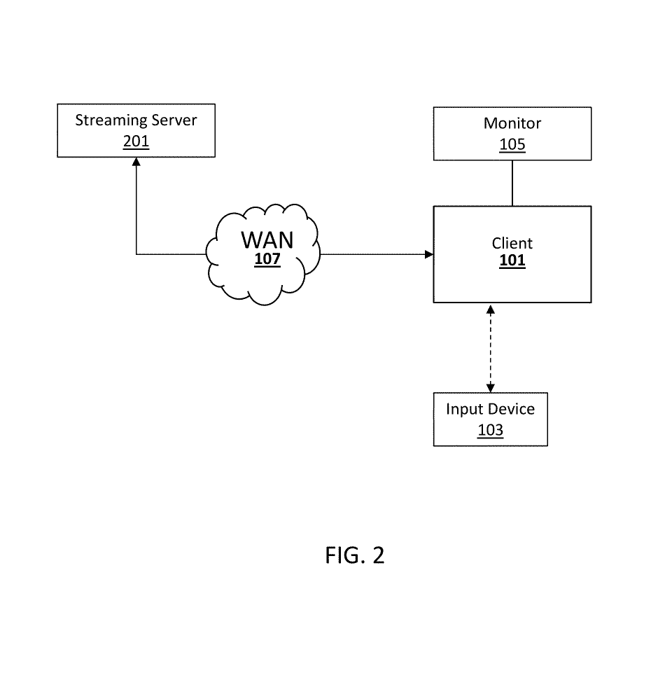

FIG. 2 illustrates a system for remote content delivery that is configured to utilize input commands in the form of device-based signals. In FIG. 2, a client device 101 having a monitor 105 and an input device 103 communicates with a streaming server 201 over a wide-area network 107. The streaming server 201 executes a game program for a user of the client device 101 and facilitates remote interaction between the user of the client device 101 and the game program.

The game program executing at the streaming server 201 is configured to receive and interpret device-based signals from the input device 103 of the client device 101 and generate content for delivery to the client device 101 in response to the received device-based signals. For example, the streaming server 201 may generate content for updating the context of the game environment being displayed at the monitor 105 of the client device 101 based on the user providing certain input commands in the form of device-based signals (e.g., moving a character on the screen based on movement from direction pad). As another example, the streaming server 201 may generate content for updating a game program menu being displayed at the monitor 105 of the client device 101 based on the user providing certain input commands in the form of device-based signals using his input device 103 (e.g., updating menu content in response to user selecting a menu item using a remote).

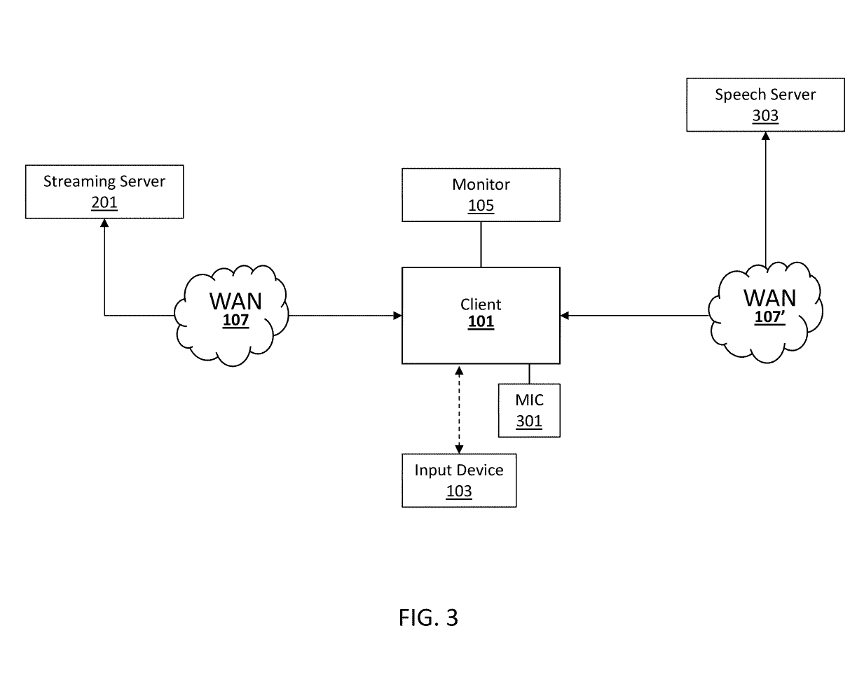

However, as mentioned above, it may be more natural for a user to interact with a game program using speech as opposed to providing input commands in the form of device-based signals using an input device. FIG. 3 illustrates a system for remote content delivery that utilizes speech-based commands according to some embodiments.

In FIG. 3, a client device 101 having a monitor 105, an input device 103 and microphone 301 communicates with a streaming server 201 and a speech server 303. As depicted in FIG. 3, the client device 101 communicates with the streaming server 201 over a first wide area network 107 and the speech server 303 over a second wide area network 107′. However, it is important to note that the client device may communicate with the streaming server 201 and the speech server 303 over the same network.

The streaming server 201 executes a game program for a user of the client device 101 that is configured to understand input commands in the form of device-based signals generated by an input device 103 of the client device 101. The game program running at the streaming server 201 is also configured to generate content for delivery to the client device 101 in response to the received input commands in the form of device-based signals. Such content may take the form of game instructions for the client device 101 or rendered graphics for the client device 101. The generated content is then transmitted to client device 101 where it is processed for display on the monitor 105.

A user of the client device 101 may interact with the game program running at the streaming server 201 by providing input commands in the form of device-based signals via the input device 103 associated with the client device 101. For example, the user of the client device 101 may control the movement of a character in the game program by moving a directional pad on the input device 103. In response to the input commands in the form of device-based signals provided by the user using the input device 103, the streaming server may generate content (e.g., game instructions or rendered graphics) that is transmitted to the client device 101 where it is processed for display on the monitor 105.

The user of the client device 101 may also interact with the game program running at the streaming server 201 by using speech-based commands. Because the game program running at the streaming server 201 is not configured to understand speech-based commands, the speech-based commands must be first translated into device-based signals that are natively understood by the game program. An example of how speech-based commands are utilized in the system for remote content delivery of FIG. 3 will now be described.

The user of the client device 101 may first provide a speech-based command to the microphone 301 associated with the client device 101. Upon recognizing that the user is speaking, the client device 101 may then transmit the speech to the speech server 303 for processing. The client device 101 may transmit speech to the speech server 303 for processing regardless of whether the speech is a command or the speech is merely conversational.

At the speech server 303, processing steps are performed to recognize the speech and convert it into a device-based signal where possible (e.g., where the speech is a command as opposed to mere conversational speech). Such processing may include first performing noise cancellation/reduction to remove noise from the speech received from the client device 101. The processing may also include speech recognition to identify what is being requested by the speech. Speech recognition may involve first translating the sound associated with the speech into words and then performing natural language parsing to identify the actual meaning of the words.

If the speech server 303 recognizes that the received speech is a command, the speech server 303 may generate input commands in the form of device-based signals that correspond to the received speech. In generating the device-based signals that correspond to the received speech, the speech server 303 may first identify the context of the game program such that the generated device-based signals correspond to the proper context. For example, the speech-based command “move to the right”, may have completely different meanings in the context of gameplay versus the context of a menu interface. In some embodiments, the speech server 303 may track the context of the game program associated with a client device 101 using metadata. In other embodiments, the speech server 303 may identify the context of the game program associated with a client device 101 by communicating with its associated streaming server 201.

As an example, if the user is looking at a menu interface for a game program and says “select multi-player mode”, the speech server 303 may generate device-based signals that may be interpreted by the game program to allow for the multi-player mode of the menu interface to be selected. Such device-based signals may take the form of directional pad inputs for moving a menu interface cursor to the multi-player mode icon followed by a select input for selecting the multi-player mode icon.

If the speech server 303 recognizes that the received speech is merely conversational speech, then the speech server 303 may not generate any device-based signals, and may wait until the next unit of speech is received for processing.

The device-based signals generated by the speech server 303 are then transmitted to the client device 101, where they are forwarded to the streaming server 201. The streaming server 201 interprets the device-based signals and generates content in accordance with the device-based signals for transmission back to the client device 101. The client device 101 then processes the content for display on the monitor 105.

Because the game programs are configured to interpret and respond to input commands in the form of device-based signals rather than speech, utilizing the speech server to recognize speech based commands and generate corresponding device-based signals allows a user of a client device 101 to interact with a game program using speech without having to modify the game program.

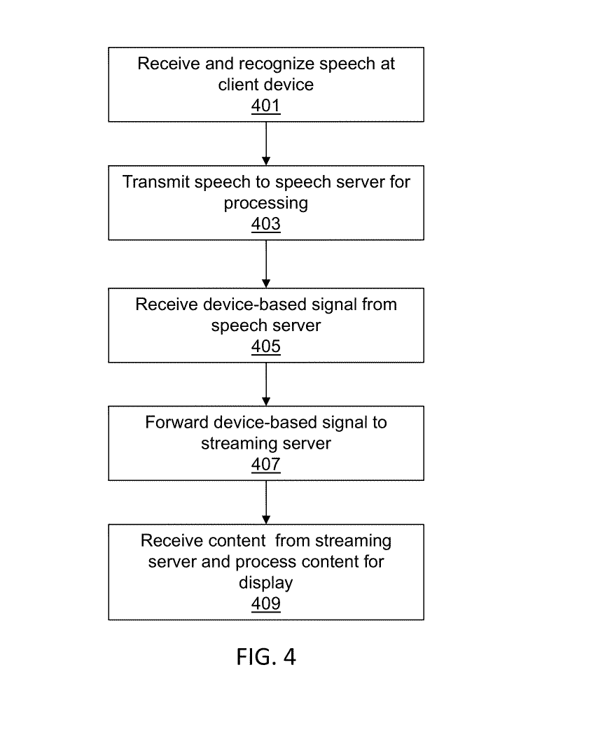

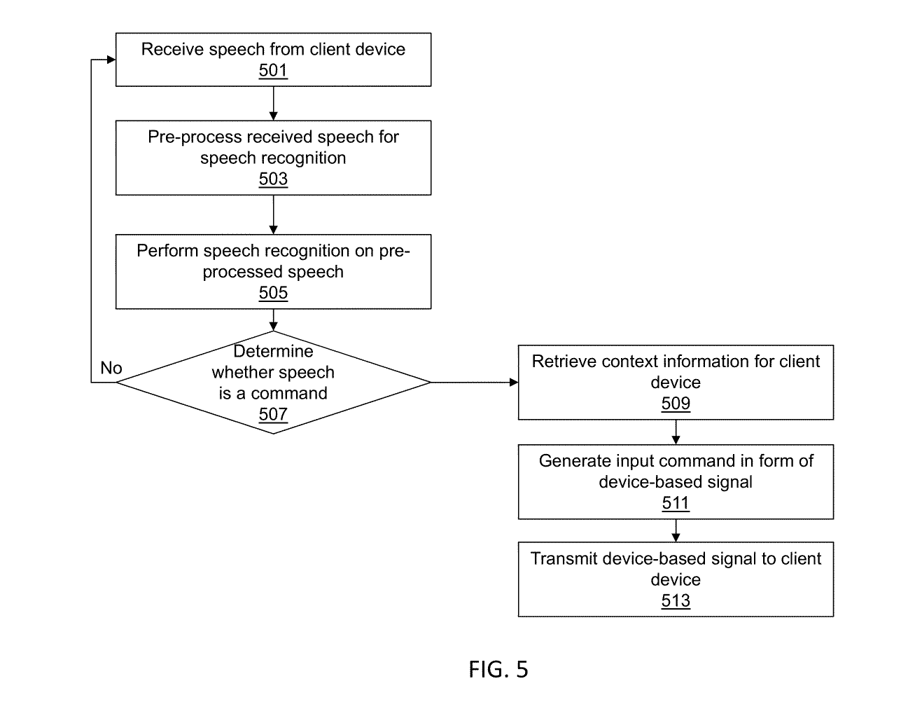

FIG. 4 is a flow diagram illustrating a method for processing speech-based commands in a system for remote content delivery according to some embodiments. FIG. 4 illustrates the steps for processing speech-based commands in the system for remote content delivery from the perspective of the client device.

Initially, speech is received and recognized by the client device as shown at 401. In some embodiments, the speech is received by a microphone associated with the client device.

The client device then transmits the speech to the speech server for processing as shown at 403. In some embodiments, the client device may identify the start and finish of a unit of speech prior to transmission. In other embodiments, the client device may continuously transmit speech that it receives to the speech server. At the speech server, processing occurs to generate a device-based signal corresponding to the speech, which will described in greater detail below.

The client device then receives the device-based signal generated by the speech server as shown at 405. In some embodiments, the device-based signal may correspond to a single input command. In other embodiments, the device-based signal may correspond to a sequence of commands.

The client device forwards the device-based signal to the streaming server as shown at 407. At the streaming server, the device-based signals are interpreted by the game program and content is generated by the game program for transmission back to the client device. The client device receives the content and processes the content for display as shown at 409.

Because the game programs are configured to interpret and respond to input commands in the form of device-based signals rather than speech, utilizing the speech server to recognize speech based commands and generate corresponding device-based signals allows a user of a client device to interact with a game program using speech-based commands without having to modify the game program.

FIG. 5 is a flow diagram illustrating a method for processing speech-based commands in a system for remote content delivery according to some embodiments. FIG. 5 illustrates the steps for processing speech-based commands in the system for remote content delivery from the perspective of the speech server.

The speech server first receives speech from the client device as shown at 501. The speech server may then pre-process the received speech for speech recognition as shown at 503. Such pre-processing may involve performing noise-cancellation to remove unwanted noise from the received speech prior to speech recognition. One ordinarily skilled in the art will recognize that various pre-processing steps may be necessary to place the received speech in condition for speech recognition.

Speech recognition may then be performed on the pre-processed speech as shown at 505. Such speech recognition may involve first translating the sound associated with the speech into words and then performing natural language parsing to identify the actual meaning of the words. Various mechanisms are available for translating the sounds associated with the speech into words and for performing natural language parsing.

Once speech recognition has been performed and the meaning of the words has been identified, a determination may be made as to whether the speech is a command or whether the speech is merely conversational as shown at 507. If it is determined that the speech is merely conversational, the method returns to step 501 where the speech server waits to receive more speech from the client device.

If however, it is determined that the speech is a command, the speech server obtains context information for the game program associated with the client device as shown at 509. In some embodiments, the speech server may track the context of the game program associated with a client device using its own metadata. In other embodiments, the speech server may identify the context of the game program associated with a client device by communicating with its associated streaming server. By identifying the context information of the game program, the speech server may accurately generate a set of input commands in the form of device-based signals. For example, the speech command “move to the right”, may have completely different meanings in the context of gameplay versus the context of a menu interface, and as such it is important for the speech server to identify the context of the game program prior to generating a set of input commands in the form of device-based signals corresponding to the speech.

After the speech server has obtained context information for the game program associated with the client device, it generates input commands in the form of device-based signals corresponding to the speech-based command for the particular context associated with the game program as shown at 511. For example, if the user of the client device is currently viewing a menu interface of the game program and says “move right”, the speech server will generate a device-based signal that moves the cursor at the menu interface to the right. Alternatively, if the user of the client device is currently is controlling a character within a gameplay context and says “move right”, the speech server will generate a device-based signal that moves the character within the game to the right.

The speech server then transmits its generated device-based signal to the client device as shown at 513. The client device then forwards the device-based signal to the streaming server, and receives content generated by the streaming server corresponding to the device-based command as discussed above.

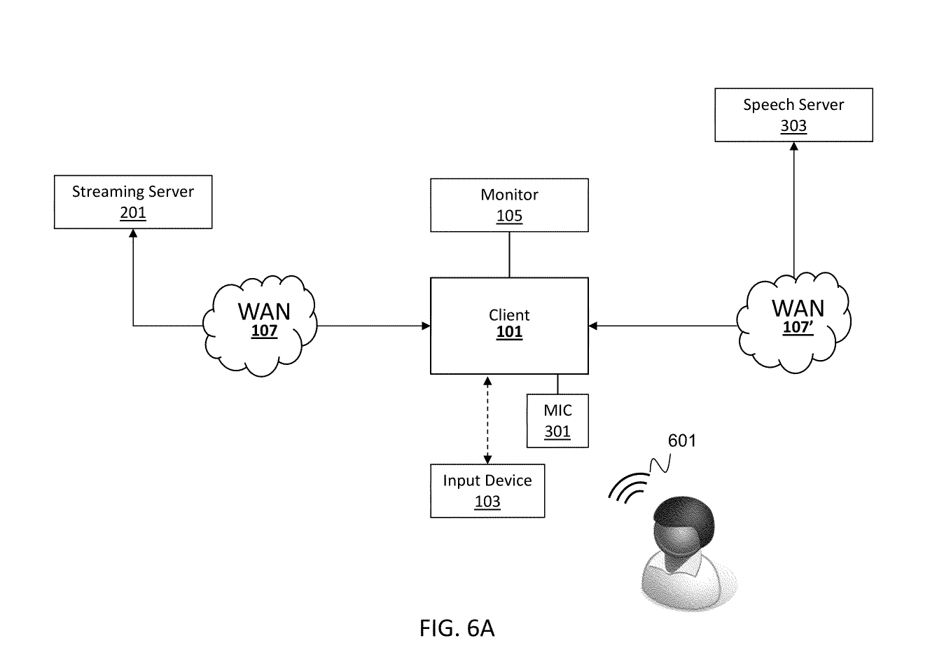

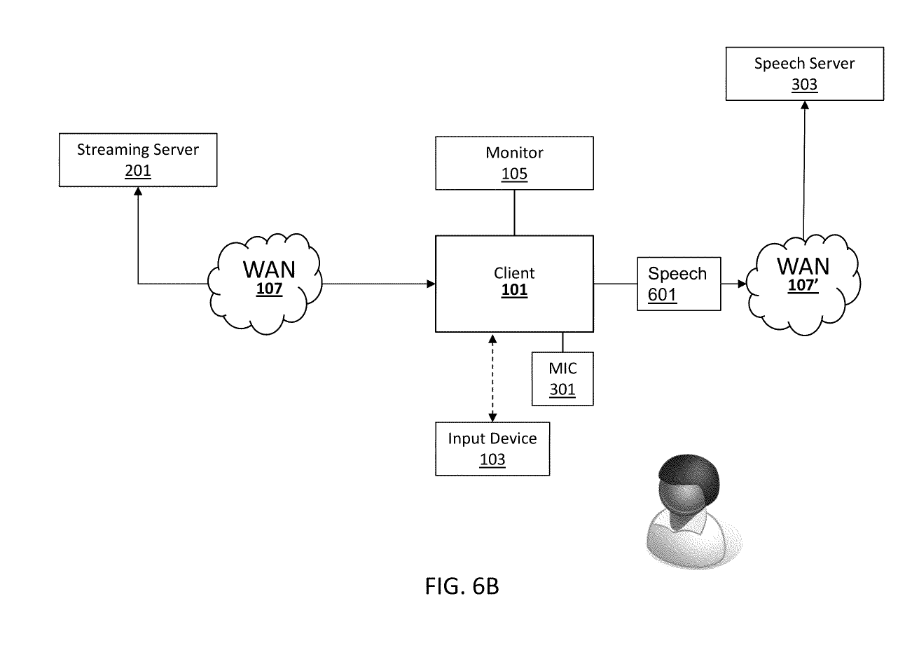

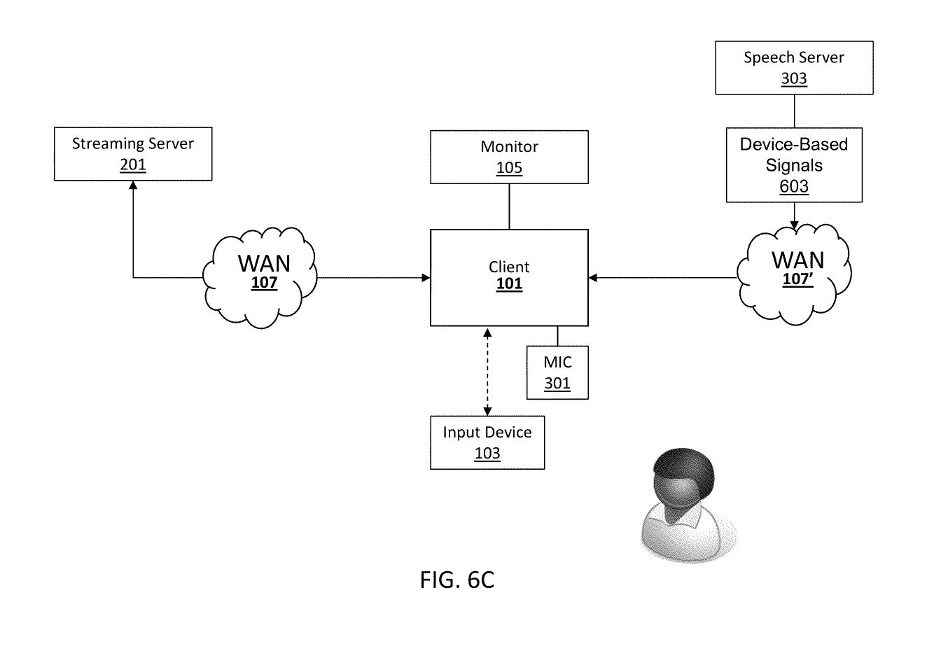

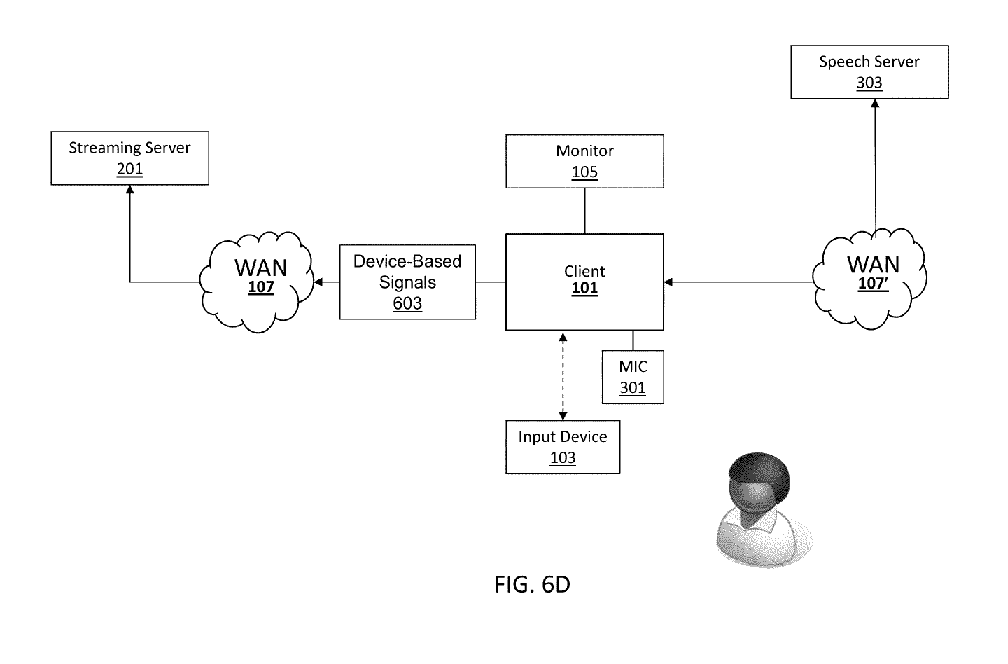

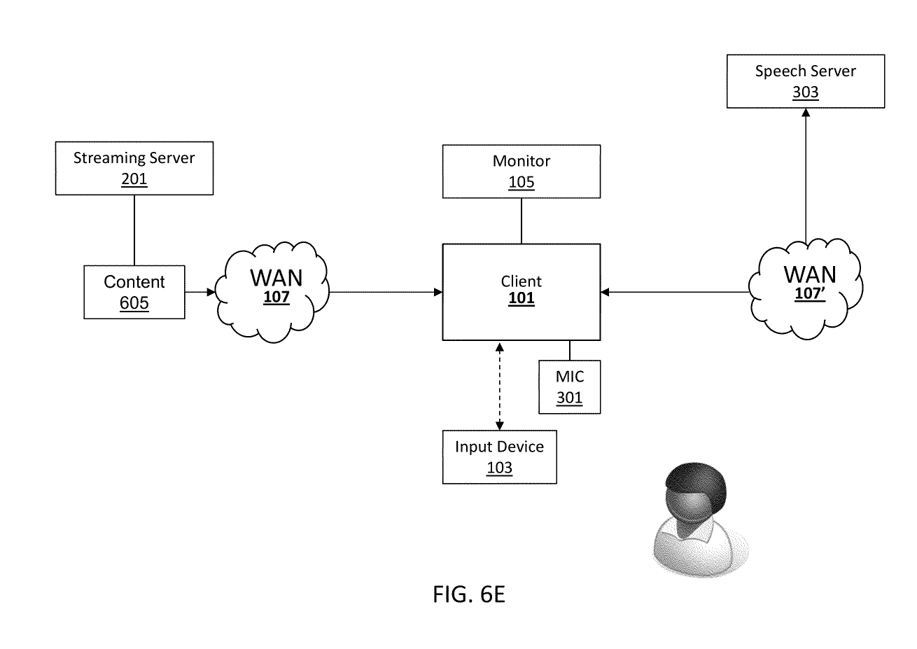

FIGS. 6A-E illustrate a method for providing and processing speech-based commands in a system for remote content delivery according to some embodiments. The system for remote content delivery in FIGS. 6A-E is substantially similar to the system described above in FIG. 3, and as such for purposes of simplicity, the components of the system for remote content delivery in FIGS. 6A-E will not be described again in detail.

Initially, a user of a client device 101 provides a speech-based command 601 which is recognized and received by a microphone 301 associated with the client device 101 as illustrated in FIG. 6A. The client device 101 then transmits the speech 601 to the speech server 303 for processing as illustrated in FIG. 6B. In certain situations, the client device 101 may identify the start and finish of a unit of speech prior to transmission. In other situations, the client device 101 may continuously transmit speech that it receives to the speech server 303. At the speech server 303, the speech is first pre-processed for speech recognition. Such pre-processing may involve performing noise-cancellation to remove unwanted noise from the received speech prior to speech recognition.

Speech recognition is then performed on the pre-processed speech. Such speech recognition may involve first translating the sound associated with the speech into words and then performing natural language parsing to identify the actual meaning of the words. Various mechanisms are available for translating the sounds associated with the speech into words and for performing natural language parsing.

Once speech recognition has been performed and the meaning of the words has been identified, a determination may be made as to whether the speech is a command or whether the speech is merely conversational. For purposes of illustration, it will be assumed that the speech is determined to be a command. The speech server 303 then obtains context information for the game program associated with the client device 101. As discussed above, the speech server 303 may track the context of the game program associated with the client device 101 using its own metadata or may alternatively identify the context of the game program associated with the client device 101 by communicating with its associated streaming server 201. After identifying the context information of the game program, the speech server 303 may accurately generate a set of input commands in the form of device-based signals corresponding to the speech-based command for the particular context associated with the game program.

The speech server 303 then transmits its generated device-based signals 603 to the client device 101 as illustrated in FIG. 6C. The client device 101 then forwards the device-based signals 603 to the streaming server as illustrated in FIG. 6D, and receives content 605 generated by the streaming server corresponding to the device-based command as illustrated in FIG. 6E.

As already mentioned above, because the game programs are configured to interpret and respond to input commands in the form of device-based signals rather than speech, utilizing the speech server to recognize speech based commands and generate corresponding device-based signals allows a user of a client device to interact with a game program using speech-based commands without having to modify the game program.

While the examples described above for utilizing speech-based commands in a system for remote content delivery employ a microphone associated with the client device, a remote device with a microphone may also be employed for utilizing speech-based commands in a system for remote content delivery.

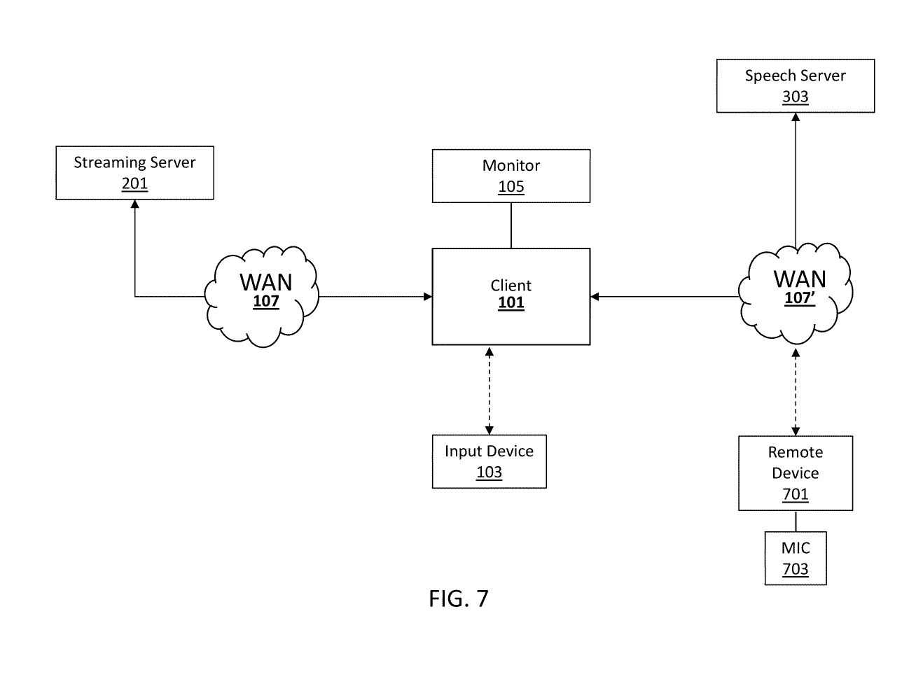

FIG. 7 illustrates an alternative system for remote content delivery that utilizes speech-based commands according to some embodiments. In FIG. 7, a client device 101 having a monitor 105 and an input device 103 communicates with a streaming server 201 and a speech server 303. A remote device 701 having a microphone 703 is associated with the client device and also communicates with the speech server 303. As depicted in FIG. 7, the client device 101 communicates with the streaming server 201 over a first wide area network 107 and the client device 101 and remote device 701 communicate with the speech server 303 over a second wide area network 107′. However, it is important to note that the client device 101 and remote device 701 may communicate with the streaming server 201 and the speech server 303 over the same network.

The streaming server 201 executes a game program for a user of the client device 101 that is configured to understand input commands in the form of device-based signals generated by an input device 103 of the client device 101. The game program running at the streaming server 201 is also configured to generate content for delivery to the client device 101 in response to the received input commands in the form of device-based signals. Such content may take the form of game instructions for the client device 101 or rendered graphics for the client device 101. The generated content is then transmitted to client device 101 where it is processed for display on the monitor 105.

A user of the client device 101 may interact with the game program running at the streaming server 201 by providing input commands in the form of device-based signals via the input device 103 associated with the client device 101. For example, the user of the client device 101 may control the movement of a character in the game program by moving a directional pad on the input device 103. In response to the input commands in the form of device-based signals provided by the user using the input device 103, the streaming server may generate content (e.g., game instructions or rendered graphics) that is transmitted to the client device 101 where it is processed for display on the monitor 105.

The user of the client device 101 may also interact with the game program running at the streaming server 201 by using speech-based commands. Because the game program running at the streaming server 201 is not configured to understand speech-based commands, the speech-based commands must be first translated into device-based signals that are natively understood by the game program.

In contrast to the system for remote content delivery of FIG. 3, the system for remote content delivery of FIG. 7 allows for a remote device 701 having a microphone 703 to be associated with the client device 101. In this way, the remote device 701 having the microphone 703 may be utilized to provide speech-based commands rather than the client device 101. The game program continues to execute at the streaming server 201 and content generated by the game program is still provided to the client device 101. However, now a user interacting with the game program is allowed to utilize a remote device 701 having a microphone 703 to provide speech-based inputs for the client device 101. This allows for speech-based commands to be utilized for interacting with a game program associated with a client device 101 even where the client device 101 does not support speech (e.g., does not have a microphone). An example of how speech-based commands are utilized in the system for remote content delivery of FIG. 7 will now be described.

A user interacting with a game program using a client device 101 may first associate a remote device 701 having a microphone 703 with the client device 101. For example, the user of the client device 101 may provide login credentials to the remote device 701 that link the remote device 703 to the client device 101.

The user then provides a speech-based command to the microphone 703 associated with the remote device 701. Upon recognizing that the user is speaking, the remote device 701 may then transmit the speech to the speech server 703 for processing. The remote device 701 may transmit speech to the speech server 303 for processing regardless of whether the speech is a command or the speech is merely conversational.

At the speech server 303, processing steps are performed to recognize the speech and convert it into a device-based signal where possible (e.g., where the speech is a command as opposed to mere conversational speech). Such processing may include first performing noise cancellation/reduction to remove noise from the speech received from the remote device 101. The processing may also include speech recognition to identify what is being requested by the speech. Speech recognition may involve first translating the sound associated with the speech into words and then performing natural language parsing to identify the actual meaning of the words.

If the speech server 303 recognizes that the received speech is a command, the speech server 303 may generate input commands in the form of device-based signals that correspond to the received speech. In generating the device-based signals that correspond to the received speech, the speech server 303 may first identify the context of the game program such that the generated device-based signals correspond to the proper context. For example, the speech-based command “move to the right”, may have completely different meanings in the context of gameplay versus the context of a menu interface. In some embodiments, the speech server 303 may track the context of the game program associated with a client device 101 or remote device 701 using metadata. In other embodiments, the speech server 303 may identify the context of the game program associated with a client device 101 or remote device 701 by communicating with its associated streaming server 201.

As an example, if the user is looking at a menu interface for a game program and says “select multi-player mode”, the speech server 303 may generate device-based signals that may be interpreted by the game program to allow for the multi-player mode of the menu interface to be selected. Such device-based signals may take the form of directional pad inputs for moving a menu interface cursor to the multi-player mode icon followed by a select input for selecting the multi-player mode icon.

If the speech server 303 recognizes that the received speech is merely conversational speech, then the speech server 303 may not generate any device-based signals, and may wait until the next unit of speech is received for processing.

The device-based signals generated by the speech server 303 are then transmitted to the client device 101, where they are forwarded to the streaming server 201. The streaming server 201 interprets the device-based signals and generates content in accordance with the device-based signals for transmission back to the client device 101. The client device 101 then processes the content for display on the monitor 105.

Because the game programs are configured to interpret and respond to input commands in the form of device-based signals rather than speech, utilizing the speech server to recognize speech based commands and generate corresponding device-based signals allows a user of a client device to interact with a game program using speech without having to modify the game program. Additionally, associating a remote device having a microphone with a client device allows for speech-based commands to be utilized for interacting with a game program associated with a client device even where the client device does not support speech.

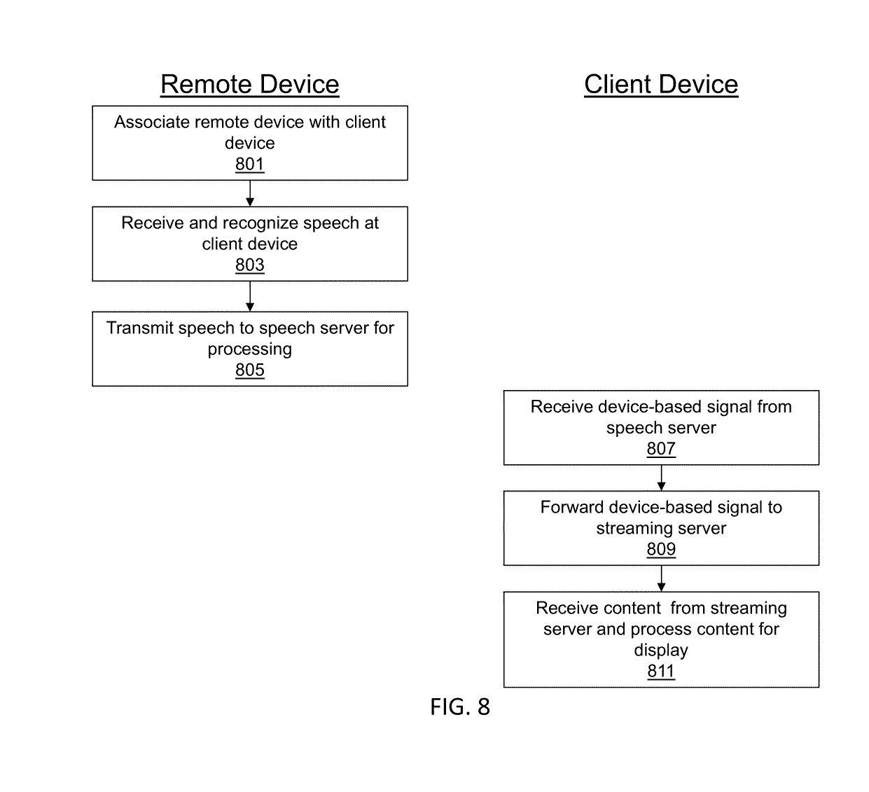

FIG. 8 is a flow diagram illustrating a method for processing speech-based commands in a system for remote content delivery according to some embodiments. FIG. 8 depicts a method for processing speech-based commands in the system for remote content delivery illustrated in FIG. 7. FIG. 8 illustrates the steps for processing speech-based commands in the system for remote content delivery from the perspective of the client device and remote device.

Initially, a remote device having means for receiving speech is associated with a client device as shown at 801. Associating the remote device with the client device may involve the user of the client device providing login credentials to the remote device to link the remote device to the client device.

Next, speech is received and recognized by the remote device associated with the client device as shown at 803. In some embodiments, the speech is received by a microphone associated with the remote device.

The remote device then transmits the speech to the speech server for processing as shown at 805. In some embodiments, the remote device may identify the start and finish of a unit of speech prior to transmission. In other embodiments, the remote device may continuously transmit speech that it receives to the speech server. At the speech server, processing occurs to generate a device-based signal corresponding to the speech, which will described in greater detail below.

The client device then receives the device-based signal generated by the speech server as shown at 807. In some embodiments, the device-based signal may correspond to a single input command. In other embodiments, the device-based signal may correspond to a sequence of commands.

The client device forwards the device-based signal to the streaming server as shown at 809. At the streaming server, the device-based signals are interpreted by the game program and content is generated by the game program for transmission back to the client device. The client device receives the content and processes the content for display as shown at 811.

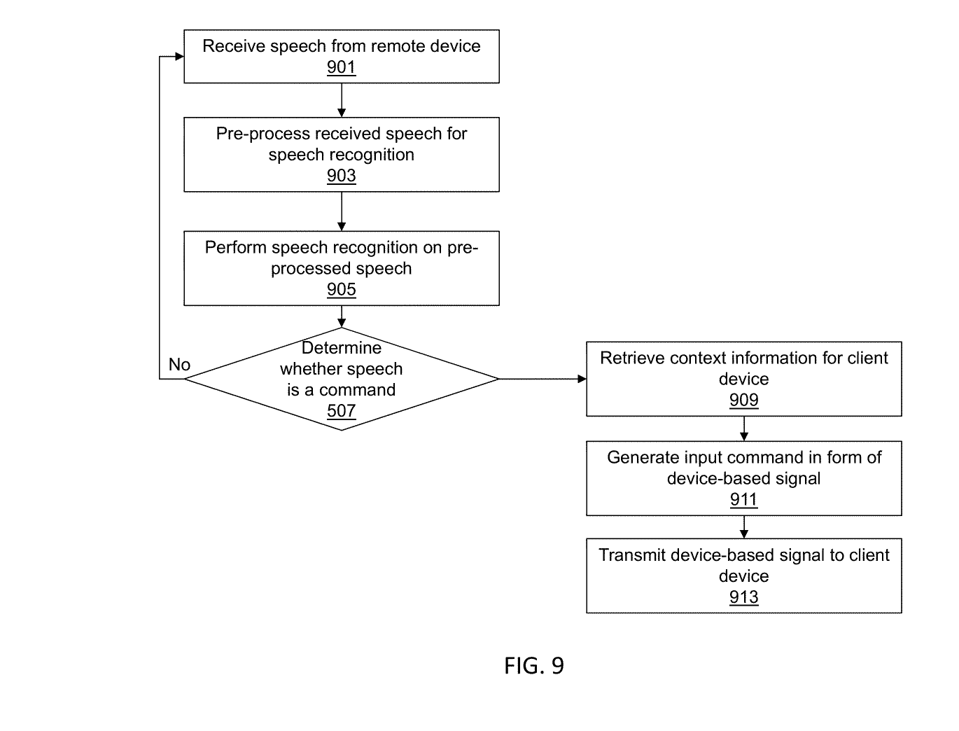

FIG. 9 is a flow diagram illustrating a method for processing speech-based commands in a system for remote content delivery according to some embodiments. FIG. 9 depicts a method for processing speech-based commands in the system for remote content delivery illustrated in FIG. 7. FIG. 9 illustrates the steps for processing speech-based commands in the system for remote content delivery from the perspective of the speech server.

The speech server first receives speech from the remote device associated with the client device as shown at 901. The speech server may then pre-process the received speech for speech recognition as shown at 903. Such pre-processing may involve performing noise-cancellation to remove unwanted noise from the received speech prior to speech recognition. One ordinarily skilled in the art will recognize that various pre-processing steps may be necessary to place the received speech in condition for speech recognition.

Speech recognition may then be performed on the pre-processed speech as shown at 905. Such speech recognition may involve first translating the sound associated with the speech into words and then performing natural language parsing to identify the actual meaning of the words. Various mechanisms are available for translating the sounds associated with the speech into words and for performing natural language parsing.

Once speech recognition has been performed and the meaning of the words has been identified, a determination may be made as to whether the speech is a command or whether the speech is merely conversational as shown at 907. If it is determined that the speech is merely conversational, the method returns to step 901 where the speech server waits to receive more speech from the remote device.

If however, it is determined that the speech is a command, the speech server obtains context information for the game program associated with the client device as shown at 909. In some embodiments, the speech server may track the context of the game program associated with a client device using its own metadata. In other embodiments, the speech server may identify the context of the game program associated with a client device by communicating with its associated streaming server. By identifying the context information of the game program, the speech server may accurately generate a set of input commands in the form of device-based signals.

After the speech server has obtained context information for the game program associated with the client device, it generates input commands in the form of device-based signals corresponding to the speech-based command received from the remote device for the particular context associated with the game program as shown at 911.

The speech server then transmits its generated device-based signal to the client device as shown at 913. The client device then forwards the device-based signal to the streaming server, and receives content generated by the streaming server corresponding to the device-based command as discussed above.

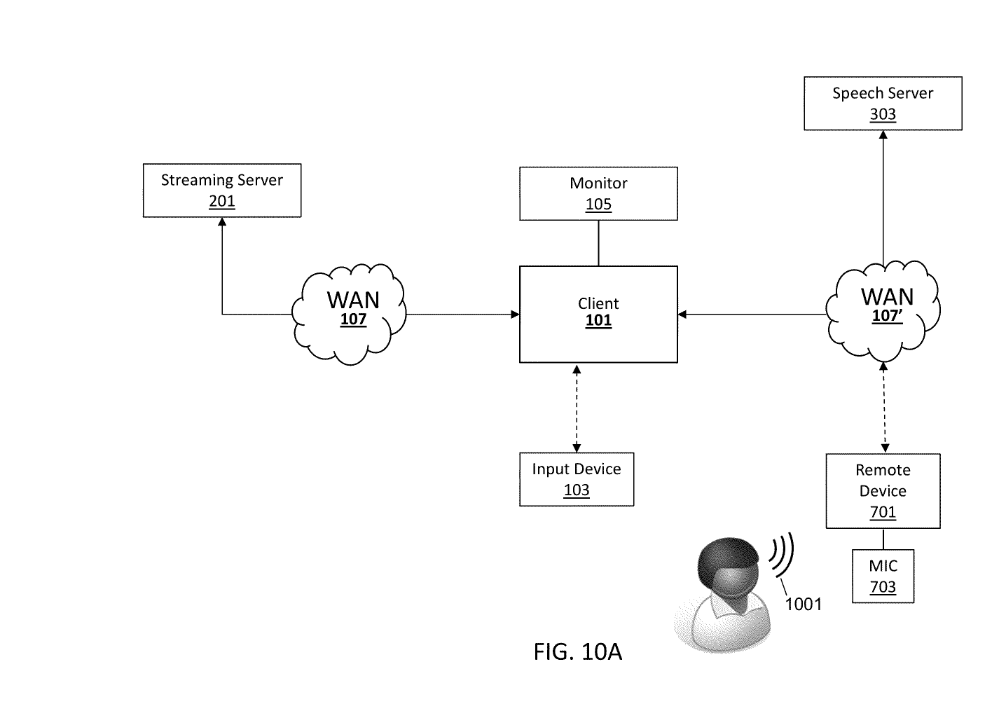

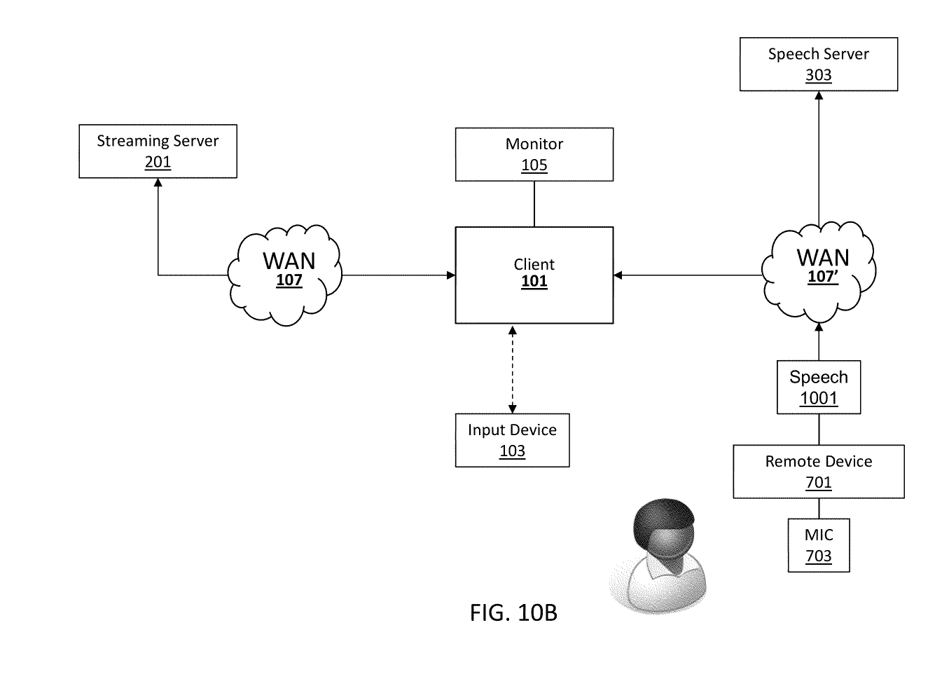

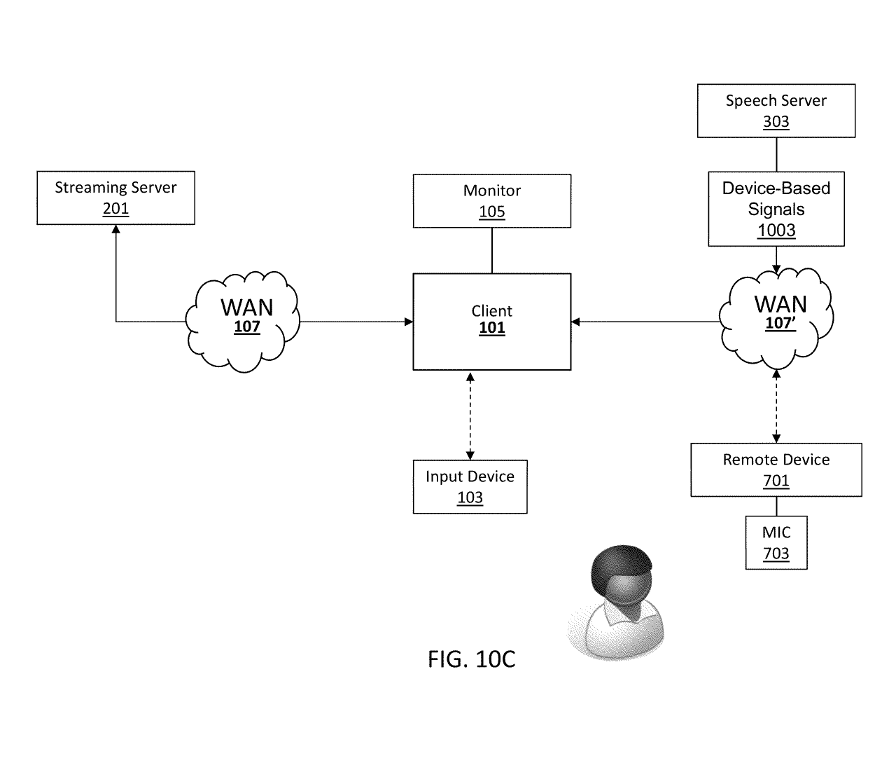

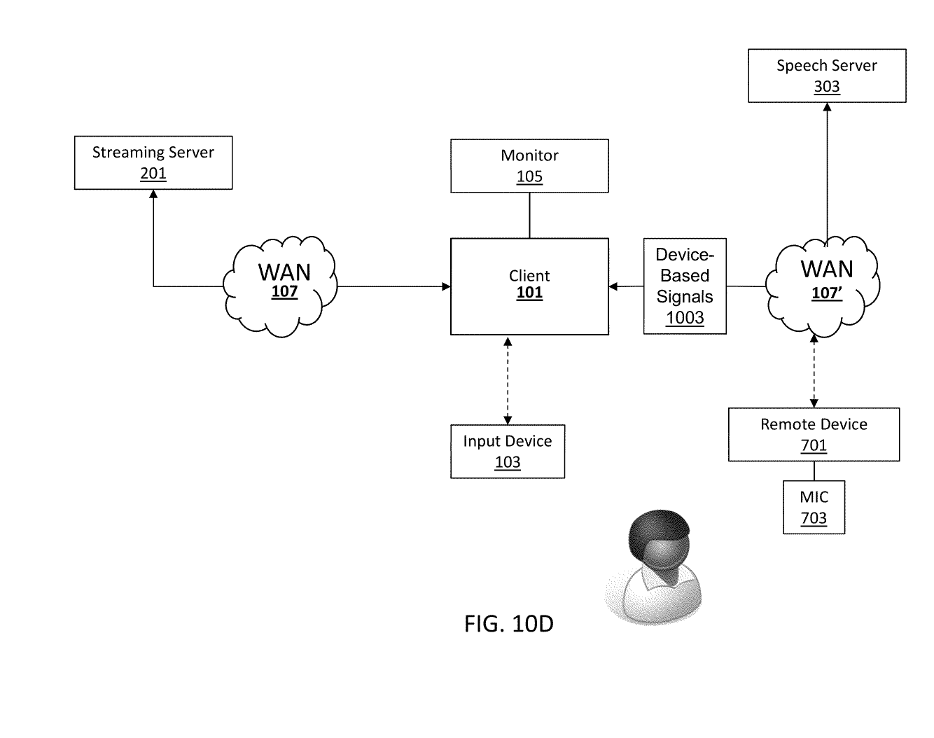

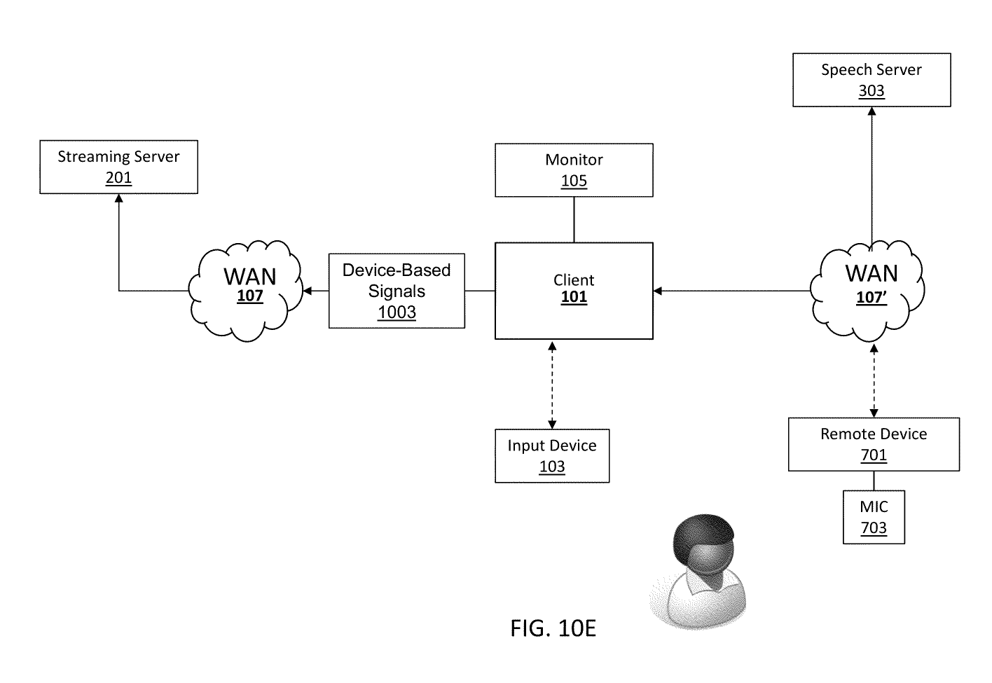

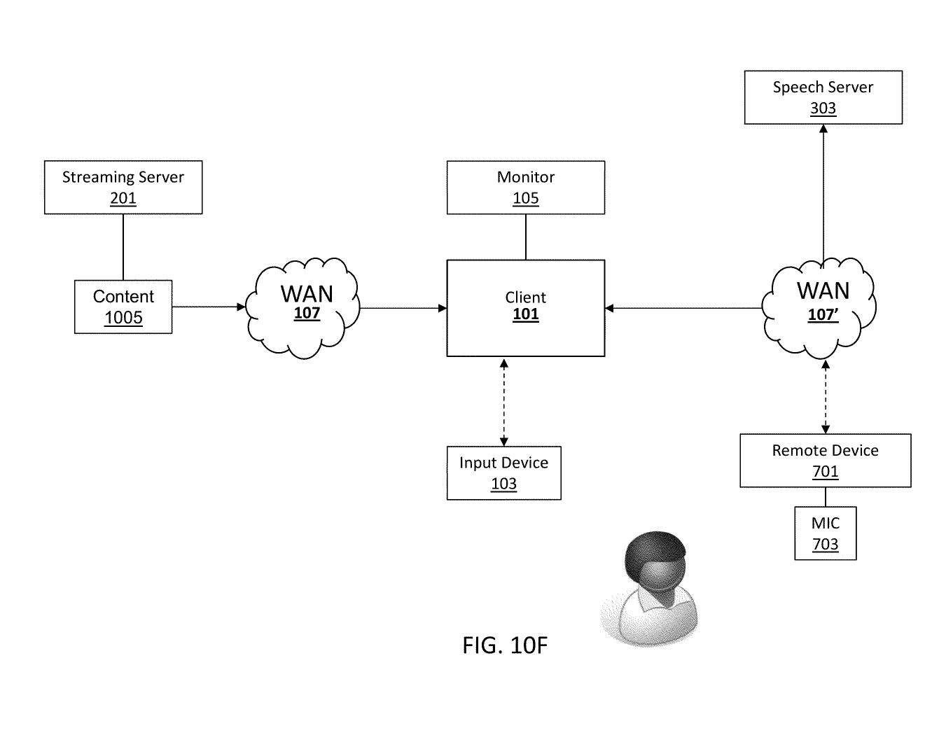

FIGS. 10A-F illustrate a method for providing and processing speech-based commands in a system for remote content delivery according to some embodiments. The system for remote content delivery in FIGS. 10A-F is substantially similar to the system described above in FIG. 7, and as such for purposes of simplicity, the components of the system for remote content delivery in FIGS. 10A-F will not be described again in detail.

Initially, a user interacting with a game program executing at the streaming server 201 provides a speech-based command 1001 to a remote device 701 associated with a client device 703 as illustrated in FIG. 10A. The speech-based command 1001 may be provided to a microphone 703 associated with the remote device 701. This is in contrast to the method for providing and processing speech-based commands depicted in FIGS. 3, 4, 5 and 6A-E, where a speech-based command is provided to the client device 101. By associating the remote device 701 having a microphone 703 with a client device 101, speech-based commands may be utilized for interacting with a game program associated with a client device 101 even where the client device 101 does not support speech.

The remote device 701 then transmits the speech 1001 to the speech server 303 for processing as illustrated in FIG. 10B. In certain situations, the remote device 701 may identify the start and finish of a unit of speech prior to transmission. In other situations, the remote device 701 may continuously transmit speech that it receives to the speech server 303. At the speech server 303, the speech is first pre-processed for speech recognition. Such pre-processing may involve performing noise-cancellation to remove unwanted noise from the received speech prior to speech recognition.

Speech recognition is then performed on the pre-processed speech. Such speech recognition may involve first translating the sound associated with the speech into words and then performing natural language parsing to identify the actual meaning of the words. Various mechanisms are available for translating the sounds associated with the speech into words and for performing natural language parsing.

Once speech recognition has been performed and the meaning of the words has been identified, a determination may be made as to whether the speech is a command or whether the speech is merely conversational. For purposes of illustration, it will be assumed that the speech is determined to be a command. The speech server 303 then obtains context information for the game program. As discussed above, the speech server 303 may track the context of the game program associated with the client device 101 using its own metadata or may alternatively identify the context of the game program associated with the client device 101 by communicating with its associated streaming server 201. After identifying the context information of the game program, the speech server 303 may accurately generate a set of input commands in the form of device-based signals corresponding to the speech-based command for the particular context associated with the game program.

The speech server 303 then transmits its generated device-based signals 1003 to the client device 101 as illustrated in FIGS. 10C and 10D. It is important to note that even though the speech command 1001 was initially provided to the speech server 303 via the remote device 701, the corresponding device-based signals 1003 are provided to the client device 101.

The client device 101 then forwards the device-based signals 603 to the streaming server as illustrated in FIG. 10E, and receives content 1005 generated by the streaming server corresponding to the device-based signals as illustrated in FIG. 10F.

As already mentioned above, because the game programs are configured to interpret and respond to input commands in the form of device-based signals rather than speech, utilizing the speech server to recognize speech based commands and generate corresponding device-based signals allows a user of a client device to interact with a game program using speech-based commands without having to modify the game program. Additionally, associating a remote device having a microphone with a client device allows for speech-based commands to be utilized for interacting with a game program associated with a client device even where the client device does not support speech.

Although the mechanism for performing speech-based commands in a system for remote content delivery has been described in the context of gaming, it is important to note that the mechanism for performing speech-based commands described above may be extended for any application or program that natively understands (e.g., interprets and responds to) input commands in the form of device-based signals rather than speech.

### System Architecture

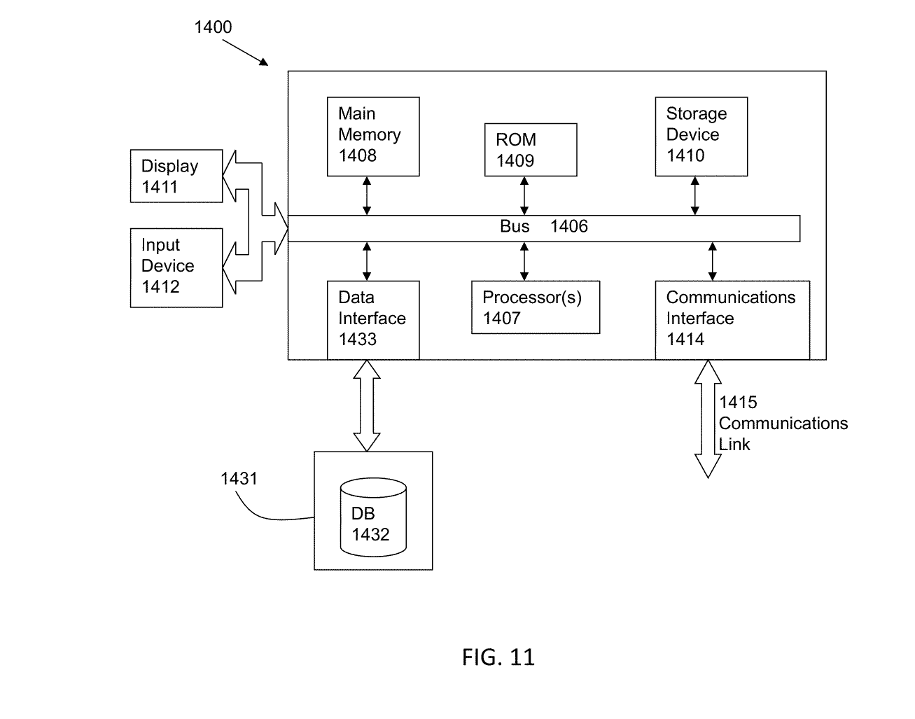

FIG. 11 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method for performing speech-based commands in a system for remote content delivery, comprising:
receiving speech;
recognizing the speech;
transmitting the speech to a speech server;
receiving a device-based signal corresponding to the speech from the speech server when the speech is a speech-based command;
forwarding the device-based signal to a streaming server; and
receiving content from the streaming server corresponding to the device-based signal.

2. The method of claim 1, wherein the speech server processes the speech to generate the device-based signal.

3. The method of claim 2, wherein processing of the speech by the speech server comprises:
performing noise-cancellation on the speech; and
performing speech recognition on the speech to identify what is being requested by the speech.

4. The method of claim 3, wherein performing speech recognition on the speech comprises:
translating sound associated with the speech into words; and
performing natural language parsing on the words to identify the meaning of the words.

5. The method of claim 2, wherein generating the device-based signal comprises identifying a context associated with the speech.

6. The method of claim 1, wherein a start and a finish of a unit of the speech is identified prior to transmitting the speech to the speech server.

7. The method of claim 1, wherein the device-based signal corresponds to a single input command.

8. The method of claim 1, wherein the device-based signal corresponds to a sequence of commands.

9. A method for performing speech-based commands in a system for remote content delivery, comprising:
associating a remote device with a client device;
transmitting speech from the remote device to a speech server;
receiving a device-based signal corresponding to the speech at the client from the speech server when the speech is a speech-based command;
forwarding the device-based signal to a streaming server; and
receiving content from the streaming server corresponding to the device-based signal.

10. The method of claim 9, wherein the speech server processes the speech to generate the device-based signal.

11. The method of claim 10, wherein processing of the speech by the speech server comprises:
performing noise-cancellation on the speech; and
performing speech recognition on the speech to identify what is being requested by the speech.

12. The method of claim 11, wherein performing speech recognition on the speech comprises:
translating sound associated with the speech into words; and
performing natural language parsing on the words to identify the meaning of the words.

13. The method of claim 10, wherein generating the device-based signal comprises identifying a context associated with the speech.

14. The method of claim 9, wherein a start and a finish of a unit of the speech is identified prior to transmitting the speech to the speech server.

15. The method of claim 9, wherein the device-based signal corresponds to a single input command.

16. The method of claim 9, wherein the device-based signal corresponds to a sequence of commands.

17. A computer program product embodied on a computer readable medium, the computer readable medium having stored thereon a sequence of instructions which, when executed by a processor causes the processor to execute a method for performing speech-based commands in a system for remote content delivery, comprising:
receiving speech;
recognizing the speech;
transmitting the speech to a speech server;
receiving a device-based signal corresponding to the speech from the speech server when the speech is a speech-based command;
forwarding the device-based signal to a streaming server; and
receiving content from the streaming server corresponding to the device-based signal.

18. The computer program product of claim 17, wherein the speech server processes the speech to generate the device-based signal.

19. The computer program product of claim 18, wherein processing of the speech by the speech server comprises:
performing noise-cancellation on the speech; and
performing speech recognition on the speech to identify what is being requested by the speech.

20. The computer program product of claim 19, wherein performing speech recognition on the speech comprises:
translating sound associated with the speech into words; and
performing natural language parsing on the words to identify the meaning of the words.

21. The computer program product of claim 18, wherein generating the device-based signal comprises identifying a context associated with the speech.

22. The computer program product of claim 17, wherein a start and a finish of a unit of the speech is identified prior to transmitting the speech to the speech server.

23. The computer program product of claim 17, wherein the device-based signal corresponds to a single input command.

24. The computer program product of claim 17, wherein the device-based signal corresponds to a sequence of commands.

25. A computer program product embodied on a computer readable medium, the computer readable medium having stored thereon a sequence of instructions which, when executed by a processor causes the processor to execute a method for performing speech-based commands in a system for remote content delivery, comprising:
associating a remote device with a client device;
transmitting speech from the remote device to a speech server;
receiving a device-based signal corresponding to the speech at the client from the speech server when the speech is a speech-based command;
forwarding the device-based signal to a streaming server; and
receiving content from the streaming server corresponding to the device-based signal.

26. The computer program product of claim 25, wherein the speech server processes the speech to generate the device-based signal.

27. The computer program product of claim 26, wherein processing of the speech by the speech server comprises:
performing noise-cancellation on the speech; and
performing speech recognition on the speech to identify what is being requested by the speech.

28. The computer program product of claim 27, wherein performing speech recognition on the speech comprises:
translating sound associated with the speech into words; and
performing natural language parsing on the words to identify the meaning of the words.

29. The computer program product of claim 26, wherein generating the device-based signal comprises identifying a context associated with the speech.

30. The computer program product of claim 25, wherein a start and a finish of a unit of the speech is identified prior to transmitting the speech to the speech server.

31. The computer program product of claim 25, wherein the device-based signal corresponds to a single input command.

32. The computer program product of claim 25, wherein the device-based signal corresponds to a sequence of commands.
